(19) United States
(12) Patent Application Publication
(10) Pub. No.: US 2006/0079260 A1
(43) Pub. Date: Apr. 13, 2006

(54) Ad-hoc dispatch chatroom

(75) Inventors: Dan Tillet, Oak Hill, VA (US); David Martin, Chantilly, VA (US); Karalyn Szuszczewicz, Haymarket, VA (US); Trinh Vu, Ashburn, VA (US)

Correspondence Address: CROWELL & MORING LLP;INTELLECTUAL PROPERTY GROUP, P.O. BOX 14300, WASHINGTON, DC, 20044-4300, US

(73) Assignee: NEXTEL COMMUNICATIONS, INC., Reston, VA (US)

(21) Appl. No.: 11/227,392

(22) Filed: Sep. 15, 2005

Related U.S. Application Data
(60) Provisional application No. 60/610,553, filed on Sep. 17, 2004.
(60) Provisional application No. 60/703,886, filed on Aug. 1, 2005.

(51) Int. Cl. H04Q 7/20

(52) U.S. Cl. 455/518; 455/507

(57) ABSTRACT

A system and method of establishing a multi-party dispatch communication session is disclosed. In accordance with an embodiment of a method of the present invention, the method includes receiving an invitation to join a multi-party dispatch communication session directed to a called party at a dispatch network. The invitation is transmitted to the called party by the dispatch network and an option is provided to the called party to either accept the invitation, decline the invitation, or defer the invitation. In accordance with an embodiment of a system of the present invention, the system includes a dispatch network where the network transmits an invitation option to a plurality of called parties to either accept an invitation to join a multi-party dispatch communication session, decline the invitation, or defer the invitation. The dispatch network establishes a multi-party dispatch communication session between a set of the plurality of called parties that accept the invitation.

This application claims the benefit of U.S. Provisional Patent Application Ser. No. 60/610,553, filed Sep. 17, 2004, and U.S. Provisional Patent Application Ser. No. 60/703,886, filed Aug. 1, 2005, the disclosures of which are herein expressly incorporated by reference.

### FIELD OF THE INVENTION

The present invention relates generally to the field of telecommunications, and in particular, to an ad-hoc dispatch chatroom.

### BACKGROUND OF THE INVENTION

Cellular communications systems typically provide interconnect and/or dispatch voice communication services. Interconnect voice communication services are those typically provided by most cellular carriers as circuit-switched communications. Dispatch communication services are commonly known as a “walkie-talkie” type of call, such as provided by Nextel Communications, Inc. and identified by the names Push-To-Talk (PTT) or Direct Connect. The popularity of dispatch calls is ever expanding and this increase in popularity has created a demand for more features to be associated with these types of calls.

Currently, dispatch communication services can typically provide private and group calls. A private dispatch call is between two parties, while a group dispatch call is between more than two parties, each of whom can converse with each of the other participants during the call. Group calls are becoming increasingly popular because they allow a subscriber to converse with numerous other subscribers in the same session. This provides particular utility in both business applications and for social communications. However, there are aspects in the way dispatch group calls are conducted today that may not be desirable in all circumstances.

One such aspect is that currently dispatch group calls are generally conducted between group members for groups that are pre-defined prior to the calls. For example, if a business person regularly needs to communicate with certain other people in the business, the person can define a group to include these other people and upon initiation of a group call to these persons, all are automatically connected into the group call if they are available, e.g., their phone is turned on and they are not utilizing the phone to communicate with someone else. Therefore, in a group call with a pre-defined group, while having significant utility, the group must be defined prior to the call, thus, reducing some of the flexibility for defining the group that may be desired in certain circumstances.

Another current method of establishing a group call that may have potential drawbacks in particular circumstances is to dynamically establish the group for the call. In this method, the group is not required to be pre-defined, as discussed above, but rather, the group members are selected by the initiator of the group call in conjunction with establishing the group call. This methodology may be referred to as a selective dynamic group call since the group members are selectively defined by the call initiator and also are dynamically defined, i.e., not pre-defined.

Whereas the selective dynamic group call can provide further flexibility over the pre-defined group call, this type of group call may also have limitations in certain circumstances. With both the pre-defined group call and the selective dynamic group call, members of the called group, if they are available for the group call, are automatically participants in the group call. Since they are members of the group, when the group call is initiated, they receive the dispatch audio communication from the group call initiator. Thus, they do not have an option as to whether or not they desire to be initially included in the call. In the current methods, the called group members are automatically participants in the call and they must opt-out of the call if they do not desire to further participate in the call.

There may be various reasons why a group member would not want to automatically be a participant in a group call, thus requiring the member to opt-out of the call after participating if they do not want to further participate. However, in the current methods of conducting a group call, the group call initiator, by initiating the call, controls the initial participation by the available group members. Whereas in the current methods for establishing a dispatch group call there may be flexibility for the group call initiator in establishing and conducting the call, the called group members have limited flexibility concerning their participation in the call.

Therefore, it would be desirable to provide an improved multi-party dispatch call capability. The improved capability could provide for flexibility for both the call initiator and the called parties in determining the composition of the members in the multi-party call.

### SUMMARY OF THE INVENTION

In accordance with an embodiment of a method of the present invention, a method for establishing a multi-party dispatch communication is provided. The method includes the acts of receiving an invitation to join a multi-party dispatch communication session directed to a called party at a dispatch network. The invitation is transmitted to the called party by the dispatch network and an option is provided to the called party to either accept the invitation, decline the invitation, or defer the invitation.

In accordance with an embodiment of a system of the present invention for establishing a multi-party dispatch communication, the system includes a dispatch network. The dispatch network transmits an invitation option to a plurality of called parties to either accept an invitation to join a multi-party dispatch communication session, decline the invitation, or defer the invitation. The dispatch network establishes a multi-party dispatch communication session between a set of the plurality of called parties that accept the invitation.

### BRIEF DESCRIPTION OF THE DRAWINGS

FIG. 1 illustrates an embodiment of an architecture for an ad-hoc dispatch chatroom in accordance with the principles of the present invention.

FIG. 2 illustrates an embodiment of a method of establishing an ad-hoc chatroom in accordance with the principles of the present invention.

### DETAILED DESCRIPTION OF THE EXEMPLARY EMBODIMENTS

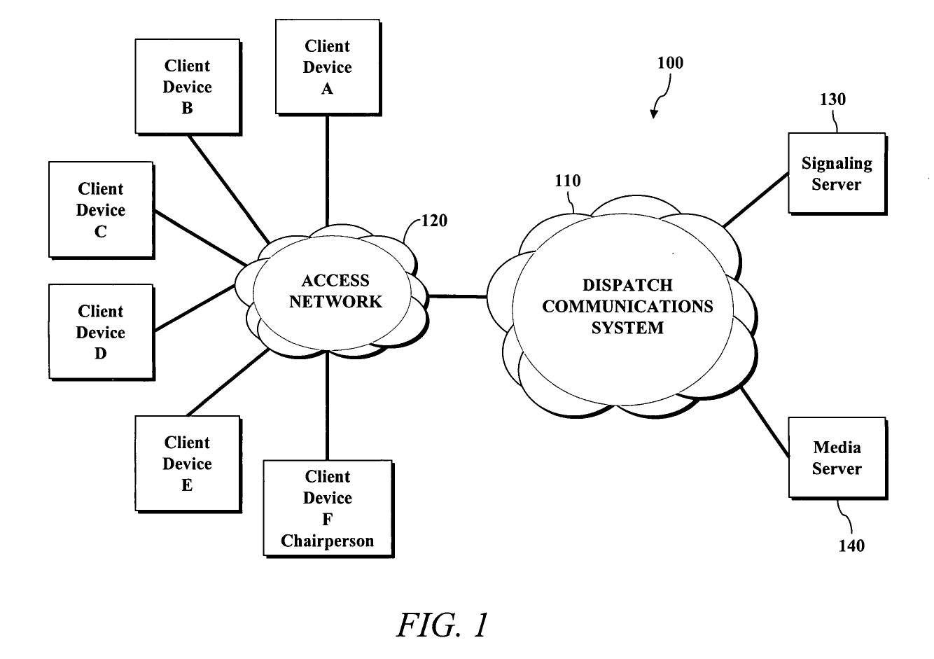

FIG. 1 illustrates an exemplary method and system in accordance with an embodiment of the present invention. As described in more detail below, in accordance with the principles of the present invention, a multi-party dispatch communication session may be conducted as an ad-hoc dispatch chatroom which includes a plurality of client communication devices A-F communicating through the dispatch network. The dispatch network 100 includes a dispatch communication system 110 and an access network 120, which may be either a wire-less or wire-line network. The dispatch network uses the signaling server 130 and media server 140 to support the ad-hoc dispatch chatroom communications. Signaling server 130, among other functions, performs call set-up, floor control and access, and call termination functions for the dispatch communication session. The client devices can be mobile telephones, IP-based telephones, desktop computers, or any other type of device which is capable of dispatch communications. As will be further explained later in this specification, one of the client devices can be associated with a chairperson of the chatroom.

Subscribers to network 100 may establish an ad-hoc chatroom through the network. In establishing an ad-hoc chatroom, invitations are sent to a group of called parties, as selected by the initiator of the chatroom, for participation in the chatroom. Each called party may decide whether to opt-in to the chatroom. That is, the called party is not a participant in the chatroom unless the called party accepts the invitation to join the chatroom. If the called party either declines the invitation or defers acting on the invitation, the called party is not a participant in the chatroom, i.e., does not hear audio communications from, nor provide communications to, other participants in the chatroom. Therefore, in accordance with the principles of the present invention, a called party is a participant in a multi-party dispatch communication only if the called party decides to accept an invitation to join the call. This is in contrast to current methods for establishing dispatch group calls where if a group member is available, e.g., their phone is turned on and they are not involved in another call, the group member is automatically a participant in the group call, i.e., can hear and provide audio in the call, and must opt-out of the call after being a participant in the call. Thus, in the present invention, invitations are sent to called parties to participate in a multi-party call and the called party is a participant in the call only if the called party accepts the invitation.

Additionally with respect to an invitee joining the chatroom, in accordance with the principles of the present invention, the joining of one invitee to the chatroom has no effect on the other invitees to the chatroom. Thus, each invitee is able to independently decide whether to join the chatroom or not, regardless of the decision of another invitee. This is in contrast to a currently known method of establishing a dispatch group call where if at least one member of the pre-defined group is available for the group call, that member is automatically joined to the call and all other available group members are automatically joined to the call. Thus, in this known method, the group members cannot individually decide to opt-in to the group call. They are automatically opted-in to the call if they are available and must then opt-out of the call if they no longer desire to participate. In the present invention, the invitee to the chatroom must opt-in to the call in order to participate.

The present invention is not limited to any particular method for sending an invitation to a called party. All that is required is that an initiator of the ad-hoc dispatch chatroom is able to identify potential participants for the chatroom and identify those participants to the dispatch network. The group of called parties is defined by the initiator of the ad-hoc chatroom contemporaneous in time with transmitting invitations to the called parties. The dispatch network sends an invitation to each potential participant that includes options for participation. The invitation can be in an audio-visual format where the recipient receives both an audible indication at their phone that they have been invited to participate and a visual indication that can be displayed on the phone. The invitation can also be sent as a text message, e.g., a short message service (SMS) message.

In accordance with another feature of the present invention, invitations can be sent for chatrooms scheduled to take place in the future. The chairperson or person sending the invitation sets the time and date of the chatroom in the invitation menu prior to sending the invitation. The invited party(s) receive the invitation and the invitation states the time and date of the scheduled chatroom. Any invitee can accept the invitation by pressing the “accept” soft key and the time/date of the chat will be stored, decline the invitation, or respond tentatively to the invitation. The sender of the invitation has the option to receive audible and user interface (UI) messages notifying him that one of the invitation recipients has responded to the invite. For those invitees who have accepted or are tentative, at the actual start of the chatroom, they will be prompted to join, decline, or snooze the invitation. The sender of the invitation can check a roll call to see who has accepted/declined/tentatively accepted the invitation and who has not yet responded. Finally, the sender can set up and send an invitation with an automatic reminder so that each invitee is reminded of the call just prior to the chatroom starting.

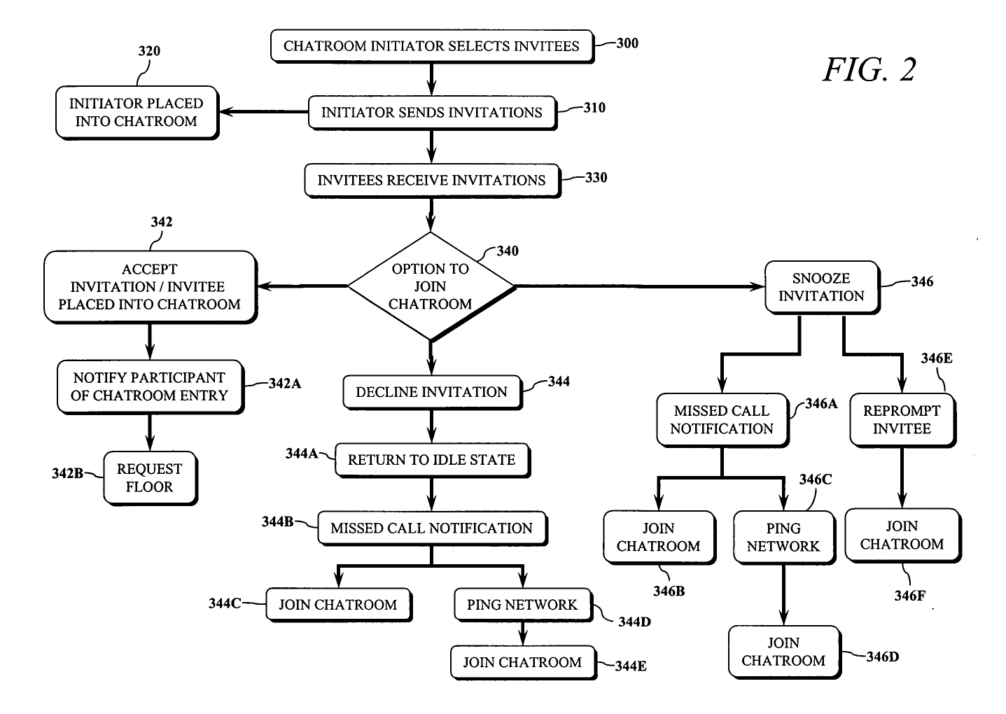

As discussed above, the potential participants in the ad-hoc chatroom dispatch call are not included in a pre-defined group. The chatroom initiator has the flexibility to identify and invite potential participants contemporaneously with the requirement for establishing the chatroom. Thus, in contrast to the method of how certain group calls are currently established by using a pre-defined group, the present invention includes the flexibility of forming a chatroom on an ad-hoc basis. As illustrated in FIG. 2 in an embodiment of a method of the present invention, in step 300 the chatroom initiator is able to select members for participation from his telephone's phonebook or enter new addresses for members not in the phonebook. After selecting the individuals or entering user addresses, in step 310 the initiator can actuate a soft key on the initiator's client device, e.g., mobile telephone, to send the invitations to the potential participants to join the ad-hoc chatroom via the network.

The initiator of the ad-hoc chatroom may be designated as the chatroom chairperson. As will be discussed further below, the chairperson has general administrative authority for conducting the chatroom. After the chairperson sends the invitations he is placed directly into the chatroom, as illustrated in step 320. The potential participants will receive the invitation in step 330 with a time/date stamp and, as discussed above, are given the option to join in step 340. In response to the option to join, the invitee may either accept the invitation and join the chatroom in step 342, decline the invitation in step 344, or snooze the invitation in step 346, e.g., defer the invitation, by pressing an appropriate softkey. Though the chairperson is placed directly into the chatroom while waiting for others to join, if the chairperson exits the chatroom prior to anyone else joining, the chatroom will stay active for a specified period of time. The chairperson will be able to re-enter the chatroom through the recent calls list on his telephone.

The chairperson may also send a chatroom invitation while he is active in a current ad-hoc chatroom. While in the chatroom, the chairperson may enter a chatroom menu and select “invite” as he would when setting up a new invitation prior to establishment of the chatroom. The chairperson also has the option to receive/disable audible and UI messages notifying him that an invite recipient has joined/declined/snoozed the chatroom invite.

The default text message appearing on the UI of an invitation recipient is “Chat invite received from “username””. An inviter may also configure his own text message to be sent instead of the default message or select from a list of predefined invite messages, such as “urgent”, “attendance required”, “please join”, etc.

Any dispatch user subscribing to the ad-hoc service provided by the dispatch network may send initial invitations to any other dispatch user. In an embodiment, the chairperson, who may be the originator of the ad-hoc chatroom, is the only person that can send an invite after the initial invitations have been sent and the chatroom is in session.

Pressing the “join” softkey in step 342 places the invitee directly into the chatroom. Acceptance of the invite by the invitee causes the invitee to be joined to the chatroom by the dispatch network. Thus, it is not until the invitee accepts the invite that the invitee is joined to the call by the network. The participant will be notified that he is active in the chatroom in step 342A, for example, via text and/or an audible tone. Once the participant is active in the call, the dispatch button on the telephone handset becomes enabled to request the floor in the dispatch ad-hoc chatroom as illustrated in step 342B. As is well known, dispatch communications are half-duplex communications where only one person at a time is able to speak. When a party has the “floor” they are able to speak during the session.

At any time during the ad-hoc chatroom the chairperson and participants may view a list of all participants currently on the call, all who were previously on the call and dropped off, and all who are on the call but have the session on hold, e.g., for the purpose of being on another call. Also, the chairperson may view the status of all invitees to the chatroom, e.g., declined, snoozed, currently on call, on hold, previously on call and dropped off, etc. The participant status information can have a time/date stamp. If the chairperson switches to another call and places the ad-hoc chatroom on hold, he will not receive audible tones and text informing him of who is joining the call. However, the chairperson may view the ad-hoc chatroom roll call to see who is on the call once he is again active in the call.

If the invitee does not respond to the invitation after a specified amount of time, e.g., if the invitee has snoozed the invite, the UI returns to its idle state and a notification is placed in the invitee's telephone “missed call” log with a time/date stamp as illustrated in step 346A. When the user is checking their missed calls, the user is given the option to join the chatroom in step 346B or ping the network in step 346C to determine if the chatroom is still in session. If it is still active, i.e., at least 1 user is in the chatroom, the user is given the option to join the chatroom in step 346D. If there is no one else in the chatroom, the user is notified that there is no one in the chatroom and the user is then prompted to return to the main menu. Alternatively, the chatroom invitation can be cleared from the user's device upon termination of the chatroom and/or the user can be provided with a recording of the chatroom session.

Further regarding the options of snoozing the invitation and declining the invitation, if a user snoozes the invitation, in step 346E the present invention may re-prompt the user to join the chatroom after a period of time. The user may then join the chatroom, as shown in step 346F. If the user declines the invitation, in step 344A the user's handset may be placed back into its idle state. Also, similar to the process described above regarding snoozing the invite, if the user declines the invitation a notification may be placed in the invitee's telephone “missed call” log with a time/date stamp as illustrated in step 344B. From the missed call log, the user can join the chatroom in step 344C or ping the network in step 344D to determine if the chatroom is still in session. If it is still active the user is given the option to join the chatroom in step 344E. If there is no one else in the chatroom, the user is notified that there is no one in the chatroom and the user is then prompted to return to the main menu. Alternatively, the chatroom invitation can be cleared from the user's device upon termination of the chatroom and/or the user can be provided with a recording of the chatroom session.

The status of the invitees will be available to the chairperson or the person who sent the invitation. A user can also set up personal reminders for chatrooms so that a notification will be sent to themselves at the time of the chatroom for prompting the user to join the chatroom, decline the chatroom, or snooze the reminder. In the event that a user is out of the network's coverage area or not powered-up when a reminder is scheduled, the user will be reminded of all missed reminders upon power-up or reentering the network's coverage area. Additionally, if invitations were directed to the user during an out-of-coverage or powered-down timeframe, the user will be prompted accordingly to consider the invitations upon power-up/regaining of coverage. The invitations sent during these times will be stored until the user can receive them.

Chatroom participants have the ability to maintain anonymity by creating an alias address. When a user sends an invitation or receives one, he has the option to join the chatroom under an alias name. Using an alias name will provide the user with privacy/anonymity, if desired. When sending an invite, the user may either select from a list of names he has set up in his personal options or can enter a new alias name under which he wants to send an invitation. When accepting an invite, the user can be prompted for an alias name under which he would like to join the chatroom. The user could then select from the list of names he has set up in his personal options or can enter a new alias name. If the user enters the chatroom with a duplicate alias name, i.e., one that is already in use by another chatroom participant, he can enter the chatroom with the selected alias but with a number provided after the alias name to distinguish him from the other participant, e.g., John(1).

Each participant in a chatroom will only be able to see the alias address, and not the primary address, of other participants. Therefore, as discussed above, a participant can maintain anonymity and protect the privacy of his personal address with respect to other participants. However, when an invitee accepts an invitation and uses an alias address, in an embodiment, the ad-hoc chatroom chairperson receives a notification that “JaneDoe@nextel.com” has accepted the invitation and has entered the chatroom as “Janie”.

Because there may be a possibility that an invitee may attempt to utilize an alias that may be inappropriate and/or offensive to certain other participants, the dispatch network may filter the alias selected for use by a participant prior to its use for a determination as to its acceptability. A user who attempts to use an inappropriate alias address, as determined by reference to a database of restricted words, will be re-prompted to either select a different alias address, enter the chatroom by using his primary ID, or not enter the chatroom. The chairperson is also able to restrict an invitee from joining the chatroom under an alias that is not acceptable as determined by the chairperson.

In order to accurately monitor and control the chatroom, the chairperson is able to see the primary account address of a user regardless of what alias the user may be using. For example, if an individual has been banned from a chatroom, he will not be able to re-enter merely by changing his alias name.

If a participant is acting inappropriately in the chatroom, the chairperson can view the user's primary ID and temporarily block him from the chatroom, making him unable to continue conversation in the chatroom since he would be dropped from the call. A UI message is sent to the user notifying him that he has been blocked. The chairperson can also permanently block him from returning to the chatroom indefinitely by blocking his primary user ID. The user will not be able to re-enter merely by changing his alias address. Only other participants who the chairperson enables with chairperson privileges for a specific chatroom may view primary user IDs and block users.

In the present invention, the blocking options include:

temporarily blocking a user for a configurable duration, e.g., 24 hours, with a warning being sent to the user;

permanently blocking the user from the chatroom after a specified number of blocks, with notification being sent to the user; and

entering narrative text in a text box by the chairperson describing the reason for the block and/or any other pertinent information regarding the block.

If the chatroom is terminated or times-out, no participants other than the originator may restart or re-invite members to the ad-hoc chatroom. Any previous participant in the chatroom who was not the chairperson/originator and who desires to reinitiate the chatroom must establish a new ad-hoc chatroom in order to do so.

A system configurable chatroom timer provides the ad-hoc chatroom with a hang time feature. Therefore, if all participants exit an ad-hoc chatroom, the chatroom will remain “active” for a specified period of time, i.e., the hang time, and will not automatically time-out. The ad-hoc chatroom participants can reenter the chatroom from their call history list during the hang time. After expiration of the hang time, the group of participants in the ad-hoc chatroom is disestablished. Additionally, in an embodiment, when the initiator of the chatroom exits the chatroom the chatroom terminates. However, alternatively, an option can be provided to leave the chatroom active for the other participants when the initiator exits.

The following are exemplary use cases for an ad-hoc chatroom in accordance with the principles of the present invention. Ed needs to meet with his on-call team, sets up an ad-hoc chatroom consisting of all team members and sends an invitation to each. Due to the last minute nature of the call, not all members can participate in the chatroom call. Half of the team determines they cannot participate in the call and opt to decline the invitation. The other half accepts the invitation, are immediately placed into the chatroom and may begin conversing. Ed receives text messages of who has opted-in and who has opted-out. For those who have opted-in, Ed also receives an audible tone notifying him of a participant entering the chatroom.

Sarah was in a meeting and forgot her phone. When she returns to her desk she sees that she missed an ad-hoc chatroom invitation from her boss. Sarah is given the option to opt-in to the call or to ping the network to see if the call is still in session. Sarah decides to ping the network by pressing the appropriate softkey. She receives a UI message that the ad-hoc chatroom is still in session and is asked if she would like to join. Sarah opts-in by pressing the join softkey and is immediately placed into the call. The chairperson of the ad-hoc chatroom receives a text message and an audible tone that Sarah has joined the chatroom.

Elizabeth needs to meet immediately with her department members who are volunteering to work the tradeshow floor. Elizabeth sets up a chatroom call to her department and from the menu window of her phone selects to send the invitations with a personal text message. Elizabeth enters the text message or selects from a list of available options, e.g., “meet me for lunch”, “urgent”, “meeting delayed”, then sends the text messages to the chatroom invitees. The personal message appears on the invitees' UI and the invitee is given the option to join the ad-hoc chatroom.

As discussed above, in an embodiment, the ad-hoc chatroom has a chairperson. While it is not required that the chatroom have a chairperson, it may be desirable for management of the chatroom. The chairperson may be the party who set up the chatroom or may be another participant in the chatroom as designated by the initiator. The chairperson may have the following privileges, which are not intended to be all inclusive, but rather, are to be understood in conjunction with the entirety of this specification:

Chairperson Privileges

View logistics of the chatroom (e.g., member list, priority levels)
View the users' primary IDs to properly manage the chatroom
Merge two chatrooms together (by a chairperson who is the
chairperson for both chatrooms) and view the details of both
chatrooms together
View roll call to see who is on the call at any given period of time, who
was on the call but now has dropped off the call, and who has put the
call on hold
Monitor the chatroom while actively participating. Monitoring a
chatroom may consist of viewing active participants, participants who
are “active” but in another session, participants who were active but
have exited, listening to chatroom conversations, and viewing
chatroom conversations via text from the desktop
Monitor the chatroom while not participating - (Voice to text
capabilities support multiple window viewing of chatrooms on the
desktop)
Scale the size, i.e., the number of possible participants, of the
chatroom while the chatroom is idle
Tear down a chatroom
Take the floor at any time
Send text messages to a participant
Break into a session, i.e., enter or become active in a chatroom that is
being passively monitored
Manage audio and text signals, e.g., to all in the chatroom when
someone has entered or exited
Ability to turn on/off audible tones/messages/UI receipts/notifications
of people joining/exiting a chat
Manage a question/answer session
Actively participate in the chatroom
Send invites to users for the respective chatroom
Manage the privileges and/or memberships of users, including:
Enable or disable select participants from taking the floor
during the chatroom, e.g., in a broadcast type of chatroom
Disconnect one or many participants without interrupting the
chatroom
Disable one or many participants from rejoining the chatroom
(temporarily or permanently)
Block users from entering a chatroom
Assign priority levels to members to enable greater floor
control
Delegate a subset of, or all, chairperson privileges to another
chatroom member

As discussed above, the chairperson may delegate all or a subset of the chairperson's privileges to one or more chatroom participants. In this circumstance, there may be a number of chairpersons, however, the original chairperson may still maintain absolute control over the chatroom, i.e., they can overrule decisions made by the other delegated chairpersons.

The below are exemplary use cases for several of the privileges discussed above for the functionality of the ad-hoc chatroom chairperson.

Rita is the chairperson of a chatroom. Rita is monitoring the chatroom and notices that a particular participant is acting inappropriately. Rita goes into the chatroom set up on her desktop, identifies the user, and terminates him from the chatroom. The termination is tagged to the primary user name, regardless of whether or not the user is using an alias name in the chatroom, so that further entry into the chatroom is prohibited regardless of the alias name used, if any.

John set up a chatroom but is called away on an emergency. As chairperson, John sets up Amy as the chatroom chairperson so that Amy can monitor the chatroom in his absence. In the meantime, it becomes clear that additional individuals need to participate in the chatroom. Therefore, Amy is able to send invitations to those additional individuals. Amy also receives notification if they join the chatroom and is able to monitor the participation of all participants.

Tom is in an ad-hoc chatroom and is the acting chairperson with the legal department. Paul is participating in the legal chatroom and is also scheduled to launch an ad-hoc chatroom with the marketing department. He puts the legal department chat on hold to start the marketing chatroom and quickly learns that the marketing department and the legal department need to converse to resolve some outstanding issues. Because Paul is not the chairperson of the legal chatroom he is not able to merge the calls together. However, Tom, being the legal chatroom chairperson, quickly assigns Paul the ability to act as chairperson of the legal chatroom by assigning him through his chatroom menu options. Paul then merges the two chatrooms together so that marketing and legal can converse in the same chatroom.

Bill is the chairperson for a chatroom sponsored by his company. During the chatroom, a presentation will be made and the company wants to prevent interruptions during the presentation. Therefore, Bill, through his chatroom menu options blocks all participants other than the presenter(s) from taking the floor during the presentation. When the presentation is over, Bill is able to unblock the other participants so that questions can be asked.

An additional functionality the chairperson has in the present invention is the ability to monitor and manage the chatroom remotely, e.g., from an internet web client device. Thus, the chairperson is able to exercise all of his privileges as discussed above remotely. For example, the chairperson is able to view participants, block participants, shut down the chatroom, start the chatroom, restrict membership (e.g., one user, a group of users via a domain, or by allowing a specific domain), disconnect participants, etc., from any remote device, e.g., a desktop computer, laptop, PDA, handset, etc. In an embodiment, as shown in FIG. 1, client device F of the chairperson would be a desktop computer with an interface to the chatroom. The chairperson would be able to hear the audio from the chatroom on the desktop as well as control the chatroom from it, as discussed above.

The below are exemplary use cases for the use of a remote device by the ad-hoc chatroom chairperson.

Tom begins a chatroom by launching the chatroom from his desktop web client. From his web interface, Tom is able to see who is on the call and can provide the sponsoring company a list of participants.

Sharon is monitoring a chatroom from her web interface. From the web she is able to disconnect one of the members who is acting inappropriately and block him from returning to the chatroom.

In accordance with another aspect of the present invention, any chatroom participant can send a text message sidebar communication to any other chatroom participant. The sidebar communication is only communicated to the sidebar participants and is not communicated to any other participant in the ad-hoc chatroom.

The disclosed embodiments are illustrative of the various ways in which the present invention may be practiced. Other embodiments can be implemented by those skilled in the art without departing from the spirit and scope of the present invention.

What is claimed is:

1. A method for conducting a multi-party dispatch communication, comprising the acts of:
receiving an invitation to join a multi-party dispatch communication session directed to a called party at a dispatch network;
transmitting the invitation to the called party by the dispatch network;
receiving an acceptance to join the multi-party communication session from the called party at the dispatch network in response to the invitation; and
joining the called party to the multi-party dispatch communication session by the dispatch network.

2. The method of claim 1 further comprising the act of defining a group of called parties for the multi-party dispatch communication session contemporaneous in time with an act of transmitting the invitation to the dispatch network.

3. The method of claim 2 further comprising the act of disestablishing the group of called parties for the multi-party dispatch communication session after expiration of a hang time.

4. The method of claim 1 further comprising the act of designating a chairperson for the multi-party dispatch communication session.

5. The method of claim 4 further comprising the act of displaying a list of participants in the multi-party dispatch communication session to the chairperson.

6. The method of claim 4 further comprising the act of displaying a status of the called party to the chairperson.

7. The method of claim 4 further comprising the act of monitoring the multi-party dispatch communication session by the chairperson through an internet interface.

8. The method of claim 4 further comprising the act of assigning a priority to the called party by the chairperson.

9. The method of claim 4 further comprising the act of assigning a function of the chairperson to the called party by the chairperson.

10. The method of claim 4 further comprising the act of preventing the called party from providing audio during a portion of the multi-party dispatch communication session by the chairperson.

11. The method of claim 4 further comprising the act of joining the multi-party dispatch communication session to a second multi-party dispatch communication session by the chairperson.

12. The method of claim 1 further comprising the act of snoozing the invitation by the called party and wherein the act of snoozing occurs prior to the act of receiving the acceptance at the dispatch network.

13. The method of claim 12 further comprising the act of providing a notification to the called party in response to the act of snoozing the invitation.

14. The method of claim 12 further comprising the act of determining whether the dispatch communication session is active and wherein the act of determining occurs subsequent to the act of snoozing.

15. The method of claim 1 wherein the act of transmitting the invitation to the called party by the dispatch network includes the act of transmitting the invitation as an audiovisual message.

16. The method of claim 1 wherein the act of transmitting the invitation to the called party by the dispatch network includes the act of transmitting the invitation as a text message.

17. The method of claim 1 further comprising the acts of:
selecting the called party from a list stored on a calling party dispatch device; and
transmitting the invitation to the called party to the dispatch network by the calling party dispatch device.

18. The method of claim 1 further comprising the acts of:
selecting the called party by entering an address for the called party on a calling party dispatch device; and
transmitting the invitation to the called party to the dispatch network by the calling party dispatch device.

19. The method of claim 1 further comprising the act of identifying the called party to other participants in the multi-party dispatch communication session by an alias name.

20. A method for establishing a multi-party dispatch communication, comprising the acts of:
receiving an invitation to join a multi-party dispatch communication session directed to a called party at a dispatch network;
transmitting the invitation to the called party by the dispatch network; and
providing an option to the called party to either accept the invitation, decline the invitation, or defer the invitation by the dispatch network.

21. The method of claim 20 further comprising the acts of:
receiving an acceptance to join the multi-party communication session from the called party at the dispatch network in response to the invitation; and
joining the called party to the multi-party dispatch communication session by the dispatch network.

22. The method of claim 20 wherein if the called party does not either accept or decline the invitation after a defined period of time a notification is stored on a dispatch device of the called party.

23. The method of claim 22 further comprising the act of providing the called party with an option of joining the multi-party dispatch communication session in response to the notification.

24. The method of claim 22 further comprising the act of determining by the called party in response to the notification whether the multi-party dispatch communication session is still being conducted.

25. The method of claim 20 wherein if the called party does not either accept or decline the invitation after a defined period of time the called party is prompted to join the multi-party dispatch communication session.

26. The method of claim 20 wherein a notification is provided to the called party at a time associated with a start of the multi-party dispatch communication session.

27. The method of claim 26 wherein the notification is provided to the called party in response to a reminder set up by the called party.

28. The method of claim 26 wherein if a dispatch device of the called party is either not powered-up or out of a coverage area of the dispatch network at the time associated with the start of the multi-party dispatch communication session then the notification is provided to the called party upon either the dispatch device powering-up or reentering the coverage area of the dispatch network.

29. The method of claim 21 further comprising the act of blocking the called party from participating in the multi-party dispatch communication session after called party is joined to the session.

30. A system for establishing a multi-party dispatch communication, comprising:
a dispatch network, wherein the dispatch network transmits an invitation option to a plurality of called parties to either accept an invitation to join a multi-party dispatch communication session, decline the invitation, or defer the invitation and wherein the dispatch network establishes a multi-party dispatch communication session between a set of the plurality of called parties that accept the invitation.

31. The system of claim 30 wherein the dispatch network disestablishes a group of called parties for the multi-party dispatch communication session after expiration of a hang time.

32. The system of claim 30 wherein the invitation option to the plurality of called parties is an audiovisual message.

33. The system of claim 30 wherein the invitation option to the plurality of called parties is a text message.
